(19) United States
(12) Patent Application Publication
(10) Pub. No.: US 2006/0041623 A1
(43) Pub. Date: Feb. 23, 2006

(54) Method and system to trigger an activity associated with a user interface element on a web page

(76) Inventor: Michael Danninger, Landau (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/920,771

(22) Filed: Aug. 17, 2004

(51) Int. Cl. G06F 15/16

(52) U.S. Cl. 709/206

(57) ABSTRACT

A method to trigger an activity associated with a user interface element on a web page. The method includes, at a first machine, generating a user interface data message. The user interface data message includes a user interface controller to receive keyboard input that includes one or more keystrokes that are entered from a keyboard associated with a second machine. The keystrokes trigger an activity associated with a user interface element on a web page. After the user interface data message is generated, the first machine communicates the user interface data message to the second machine.

### FIELD OF THE INVENTION

An embodiment relates generally to the technical field of data communications via a network, in one exemplary embodiment, to trigger an activity associated with a user interface element on a web page.

### BACKGROUND OF THE INVENTION

The entry of information from a computer with a browser may sometimes be hindered by different data entry mechanisms. For example, a user may enter one type of information with a keyboard and another type of information with a mouse. The keyboard is typically utilized to enter personal information such as a name, an address or a telephone number. On the other hand, the mouse is typically utilized to navigate between web pages (e.g., selection of a hypertext link), to select one item from a group of items (e.g., selection of a radio button), or to select multiple items from a group of items (e.g., selection of check boxes). Thus, a user may be required to alternate between the mouse and the keyboard based on the task at hand and the particular design of a web page. Casual users might consider the alternating to be a minor inconvenience; however, users that enter a large volume of data might consider the alternating to be a hindrance to their efficiency.

### SUMMARY OF THE INVENTION

According to one aspect, there is provided a method to trigger an activity associated with a user interface element on a web page. The method includes, at a first machine, generating a user interface data message that includes a user interface controller to receive keyboard input that includes at least one keystroke that is entered from a keyboard associated with a second machine. The at least one keystroke triggers the activity associated with the user interface element on the web page. At the first machine, communicating the user interface data message from the first machine to the second machine.

According to a second aspect, there is provided a method to reconfigure keyboard input that is utilized to trigger an activity associated with a user interface element on a web page. The method includes, at a first machine, generating a user interface data message that includes a user interface controller to receive keyboard input that includes the at least one keystroke entered from a keyboard associated with a second machine. The at least one keystroke is a reconfiguration of the keyboard input that is utilized to trigger the activity associated with the user interface element on the web page. At the first machine, communicating the user interface data message from the first machine to the second machine.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system, according to one exemplary embodiment of the present invention;

FIG. 2 is a block diagram illustrating enterprise applications and services, in one exemplary embodiment of the present invention;

FIG. 3 is a block diagram illustrating hardware and software components, according to an exemplary embodiment of the present invention;

FIG. 4 is a block diagram illustrating a user interface library, a user interface component with an accompanying model and a control library, according to an exemplary embodiment of the present invention;

FIG. 5 is a flow chart illustrating a method, according to an exemplary embodiment of the present invention, to trigger an activity associated with a user interface element on a webpage;

FIG. 6 is a flow chart illustrating a method, according to an exemplary embodiment of the present invention, to generate and communicate a user interface data message;

FIG. 7 is a flow chart illustrating a method, according to an exemplary embodiment of the present invention, to reconfigure keyboard input that is utilized to trigger an activity associated with a user interface element on a web page;

FIGS. 8-14 illustrate user interface screens, according to an exemplary embodiment of the present invention; and

FIG. 15 illustrates a diagrammatic representation of a machine, in the exemplary form of a computer system, within which a set of instructions, for causing the machine to perform any one or more of the methodologies discussed herein, may be executed.

### DETAILED DESCRIPTION

A method and system to trigger an activity associated with a user interface element on a web page are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a system to trigger an activity associated with a user interface element on a web page. A user may be entering personal information into a web page for a customer (e.g., name, address, telephone number) from a keyboard. Next, the user may desire to navigate to another web page (e.g., hypertext link), or to select one item from a group of items (e.g., radio button), or to select multiple items from a group of items (e.g., check boxes). The user may read a keyboard shortcut from the web page (e.g., one or more keystrokes) that is associated with a user interface element (e.g., hypertext link, radio button, check box, etc.) and enter the keyboard shortcut from a keyboard thus triggering an activity associated with the user interface element. Thus, the user is not required to alternate between utilizing the keyboard and utilizing the mouse; but rather, may complete a sequence of tasks solely from the keyboard.

In another embodiment of the present invention, a user reconfigures a keyboard shortcut that is utilized to trigger an activity associated with a user interface element on a web page. To reconfigure a particular user interface element, the user tabs through user interface elements on a web page to select the desired user interface element. Next, the user enters the keystrokes (e.g., keyboard shortcut) that the user desires to associate with the selected user interface element. Henceforth, the activity that is associated with the selected user interface element is triggered responsive to entry of the keyboard shortcut from the keyboard.

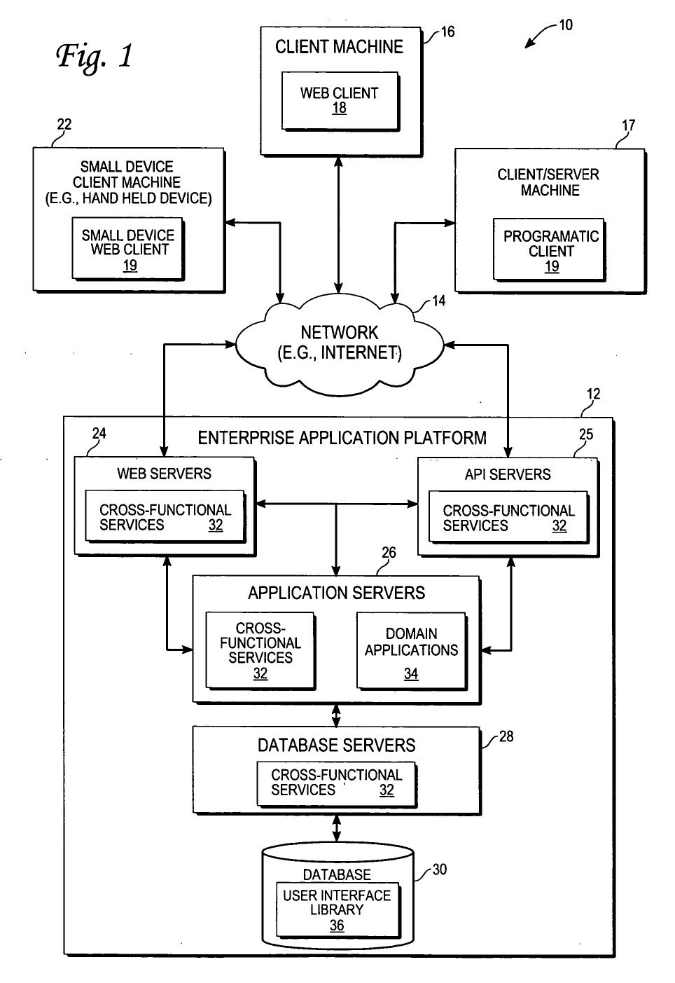

FIG. 1 is a network diagram depicting a system 10, according to one exemplary embodiment, having a client-server architecture. A platform (e.g., machines and software), in the exemplary form of an enterprise application platform 12, provides server-side functionality, via a network 14 (e.g., the Internet) to one or more clients. FIG. 1 illustrates, for example, a client machine 16 with web client 18 (e.g., a browser, such as the INTERNET EXPLORER browser developed by Microsoft Corporation of Redmond, Washington State), a small device client machine 22 with a small device web client 19 (e.g., a browser without a script engine) and a client/server machine 17 with a programmatic client 19.

Turning specifically to the enterprise application platform 12, web servers 24, and Application Program Interface (API) servers 25 are coupled to, and provide web and programmatic interfaces to, application servers 26. The application servers 26 are, in turn, shown to be coupled to one or more databases servers 28 that facilitate access to one or more databases 30. The web servers 24, Application Program Interface (API) servers 25, and database servers 28 host cross-functional services 32. The application servers 26 host domain applications 34 and cross-functional services 32.

The cross-functional services 32 provide services to users and processes that utilize the information enterprise application platform 12. For instance the cross-functional services 32 provide portal services (e.g., web services), database services and connectivity to the domain applications 34 for users that operate the client machine 16, the client/server machine 17 and the small device client machine 22. In addition, the cross-functional services 32 provide an environment for delivering enhancements to existing applications and for integrating third party and legacy applications with existing cross-functional services 32 and domain applications 34. Further, while the system 10 shown in FIG. 1 employs a client-server architecture, the present invention is of course not limited to such an architecture, and could, for example, equally well find application in a distributed, or peer-to-peer, architecture system.

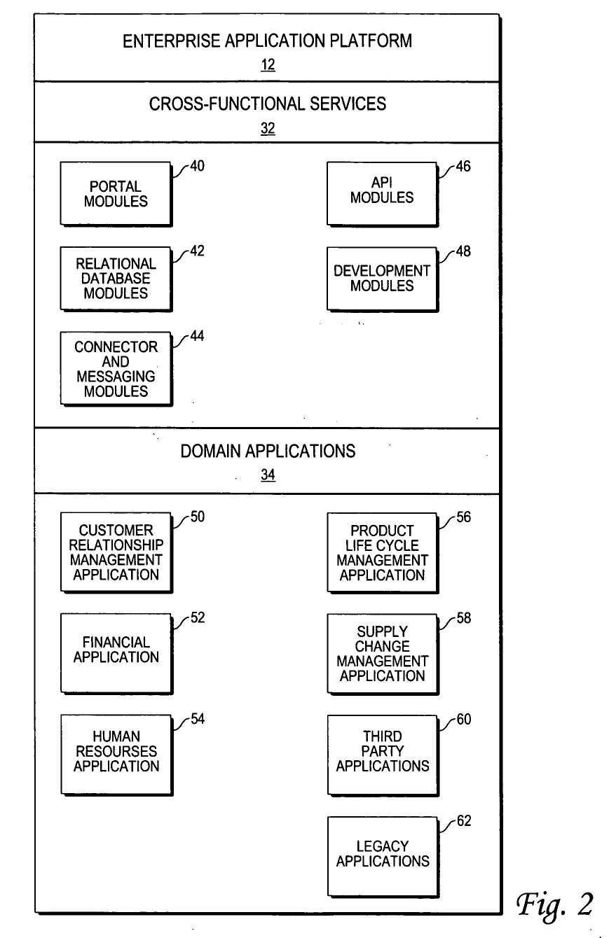

FIG. 2 is a block diagram illustrating enterprise applications and services as embodied in the enterprise application platform 12, according to an exemplary embodiment. The enterprise application platform 12 includes cross-functional services 32 and domain applications 34. The cross-functional services 32 include portal modules 40, relational database modules 42, connector and messaging modules 44, application processing interface (API) modules 46, and development modules 48.

The portal modules 40 enable a single point of access to other cross-functional services 32 and domain applications 34 for the client machine 16, the small device client machine 22 and the client/server machine 17. The portal modules 40 are utilized to process, author and maintain web pages that present content (e.g., user interface elements and navigational controls) to the user. For example, in one embodiment the portal modules may be utilized to generate and regenerate a Human Resources web page or a Salary Information web page, as discussed further below. In addition, the portal modules 40 enable user roles, a construct that associates a role with a specialized environment that is utilized by a user to execute tasks, utilize services and exchange information with other users and within a defined scope. For example, the role determines the content that is available to the user and the activities that the user may perform. The portal modules 40 include a generation module 64, a communication module 66, a dispatch module 78 and activity modules 80 that are discussed further below. In addition the portal modules 40 comply with a variety of Internet technologies and web services standards, including Java, J2EE, SAP's Advanced Business Application Programming Language (ABAP) and Web Dynpro, XML, JCA, JAAS, X.509, LDAP, WSDL, WSRR, SOAP, UDDI and Microsoft.NET.

The relational database modules 42 provide support services for access to the database 30 that includes a user interface library 36. The relational database modules 42 provide support for object relational mapping, database independence and distributed computing. The relational database modules 42 are utilized to add, delete, update and manage database elements.

The connector and messaging modules 44 enable communication across different types of messaging systems that are utilized by the cross-functional services 32 and the domain applications 34 by providing a common messaging application processing interface. The connector and messaging modules 44 enable asynchronous communication on the enterprise application platform 12.

The application processing interface (API) modules 46 enable the development of service-based applications by exposing an interface to existing and new applications as services. Repositories are included in the platform as a central place to find available services when building applications.

The development modules 48 provide a development environment for the addition, integration, updating and extension of software components on the enterprise application platform 12 without impacting existing cross-functional services 32 and domain applications 34.

Turning to the domain applications 34, the customer relationship management applications 50 enables access to and facilitates collecting and storing of relevant personalized information from multiple data sources and business processes. Enterprise personnel that are tasked with developing a buyer into a long-term customer may utilize the customer relationship management applications 50 to provide assistance to the buyer throughout a customer engagement cycle.

The financial applications 52 may be utilized by enterprise personal and business processes to track and control financial transactions within the enterprise application platform 12. The financial applications 52 facilitate the execution of operational, analytical and collaborative tasks that are associated with financial management. Specifically, the financial applications 52 enable the performance of tasks related to financial accountability, planning, forecasting, and managing the cost of finance.

The human resource applications 54 may be utilized by enterprise personal and business processes to manage, deploy, and track enterprise personal. Specifically, the human resource applications 54 enable the analysis of human resource issues and facilitate human resource decisions based on real time information.

The product life cycle management applications 56 enable the management of a product throughout the life cycle of the product. For example, the product life cycle management applications 56 enable collaborative engineering, custom product development, project management, asset management and quality management among business partners.

The supply chain management applications 58 enable monitoring of performances that may are observed in supply chains. The supply chain management applications 58 facilitate adherence to production plans and on-time delivery of products and services.

The third party applications 60 as well as legacy applications 62 may be integrated with domain applications 34 and utilize cross-functional services on the enterprise application platform 12.

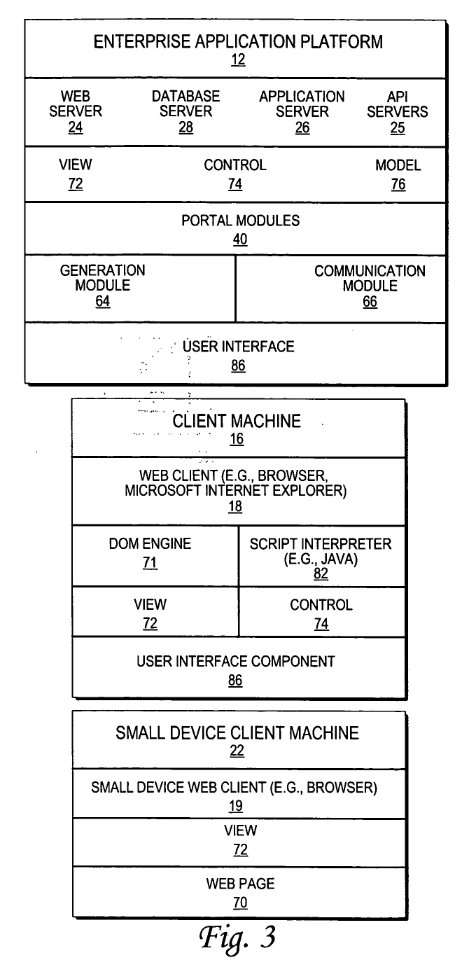

FIG. 3 illustrates hardware and software components utilized by an enterprise application platform 12, according to an embodiment. The illustrated hardware components include the enterprise application platform 12 that includes the servers previously described, the client machine 16 and the small device client machine 22. The enterprise application platform 12 includes a view, control, model construct and portal modules 40.

The view construct 72, controller construct 74, and model construct 76 illustrate a development pattern that is utilized to decouple user interface interaction into three distinct roles. The portal modules 40 include one or more user interface components 86, a generation module 64, and a communication module 66 that are collectively utilized to process user interface requests, generate user interface data messages, communicate user interface data messages, communicate user interfaces and regenerate user interfaces. A user interface component 86 is generally associated with a particular area of a user interface (e.g., web page). Although a single user interface component 86 is illustrated it should be noted that a user interface component 86 may be nested inside of another user interface component 86.

The client machine 16 includes a web client 18 that provides a platform for a DOM engine 71, a script interpreter 82, and one or more user interface components 86. The web client 18 enables a user to generate user interfaces, regenerate user interfaces and display user interfaces (e.g., web pages) that are downloaded from the web server 24 in the form of one or more user interface components 86. The display object model (DOM) engine 71 includes an Application Program Interface (API) to manipulate HTML screen objects which are examples of user interface elements that are included as meta-data in a user interface component 86. For example, a user interface element may be a graphical image of a table, a list of items, text, numeric data, a menu of selectable links, a calendar with selectable date entries, etc. The DOM API provides access for manipulation of the user interface elements by software components in the user interface component 86 the web client 18. The user interface component(s) 86 include script that may be interpreted by the script interpreter 82. The user interface components 86 may be communicated to the web client 18 by the enterprise application platform 12.

The small device client machine 22 utilizes a small device web client 19 to display a web page 70 that is communicated to the small device client machine 22 from the enterprise application platform 12. Note that the small device web client 19 does not include a script interpreter 82.

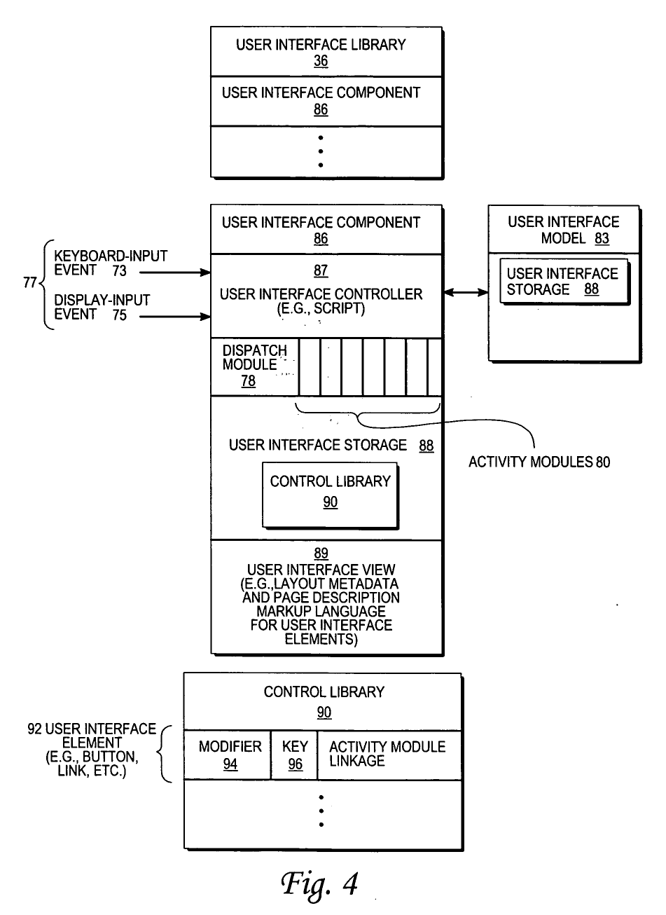

FIG. 4 is a block diagram illustrating a user interface library 36, a user interface component 86 with an accompanying user interface model 83, and a control library 90, according to an embodiment. The user interface library 36 includes user interface components 86 that are utilized to generate web pages for the enterprise application platform 12.

The user interface view 89 includes parts of the user interface component that interact with the user. For example the user interface view 89 includes layout metadata and page description markup language (e.g., HTML, etc.) to generate, format, and display user interface elements 92. The layout metadata defines the layout of user interface elements 92 on the screen of a client device (e.g., the client machine 16, the small device client machine 22 or the client/server machine 17). The user interface elements 92 may include content (e.g., text, graphics, images, audio, etc.) and navigational controls (e.g., Button, checkbox, radio button group, links, etc.). Selecting a navigational control from a display (e.g., with a mouse, rollerball, etc.) may result in communicating a display-input event 75 to the user interface controller 87. Entering keystrokes from a keyboard (e.g., a keyboard shortcut) may result in communicating a keyboard-input event 73 to the user interface controller 87.

The user interface component 86 includes a user interface controller 87, user interface storage 88, a user interface view 89 and a user interface model 83. The user interface controller 87 processes input events 77 (e.g., display-input event 75, keyboard-input event 73, etc.) to determine the next user interface view(s) 89 to be displayed or to update the present user interface view 89 accordingly. The user interface controller 87 may read and store data in the user interface model 83 (e.g. as illustrated with an arrow 79). The user interface model 83 is an object or application that includes memory for storage. The user interface model 83 hides business logic and persistence layers from the other parts of the user interface component 86 (e.g., view and control). The user interface controller 87 further includes user interface logic in the form of script including a dispatch module 78, and one or more activity modules 80. The dispatch module 78 processes the input events 77 to identify the corresponding activity module 80 by utilizing a control library 90 as described further below.

The user interface storage 88 is utilized as private memory by the user interface controller 87. The user interface storage 88 is organized as a hierarchical structures of objects (e.g., that may reference sub-objects) that include data elements that may be bound to user interface elements 92 and/or attributes in the user interface model 83. In addition, the data elements in the user interface storage 88 of one user interface component 86 may be bound to a data element in another user interface component 86. The notion of binding implies an automatic flow of data between corresponding data elements, model attributes and user interface elements. Thus, data may travel automatically from a user interface element 92 to a user interface controller 87, to other another user interface controller 87 or to the user interface model 83 and vice versa. The user interface storage 88 includes a control library 90. The control library 90 includes multiple entries, each entry corresponding to a user interface element 92 included in the user interface view 89. The control library 90 is utilized by the dispatch module 78 to process an input event 77. For example, the dispatch module 78 may compare keyboard input that is included in a keyboard-input event 73 with a modifier 94 field and key 96 field in the control library 90 to identify a match and thereafter to invoke the corresponding activity module 80. Further, the control library 90 may support various keyboard scripts (e.g., an Arabic keyboard script, a Baltic keyboard script, a Central European keyboard script, a Cyrillic keyboard script, a Greek keyboard script, a Hebrew keyboard script, a Turkish keyboard script and a Western keyboard Script, etc. . .)

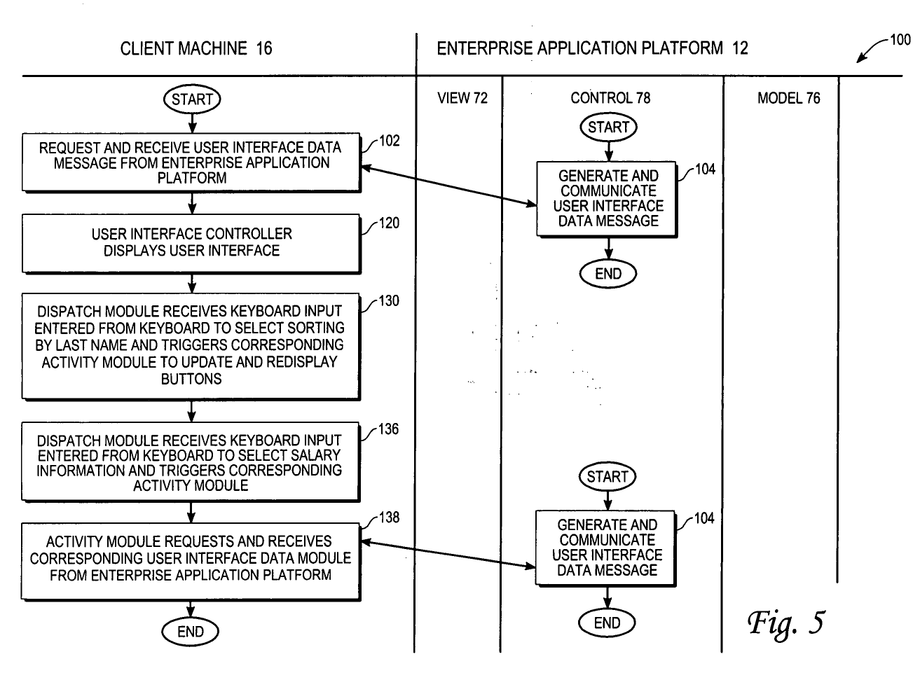

FIG. 5 illustrates a method 100, according to an embodiment, to trigger an activity associated with a user interface element on a web page. The client machine 16 is illustrated on the left and the enterprise application platform 12 is illustrated on the right.

At box 102, a user at the client machine 22 selects a link for a Human Resource Information web page, for example. In response, the client machine 16 communicates a request for the Human Resource Information web page to the enterprise application platform 12.

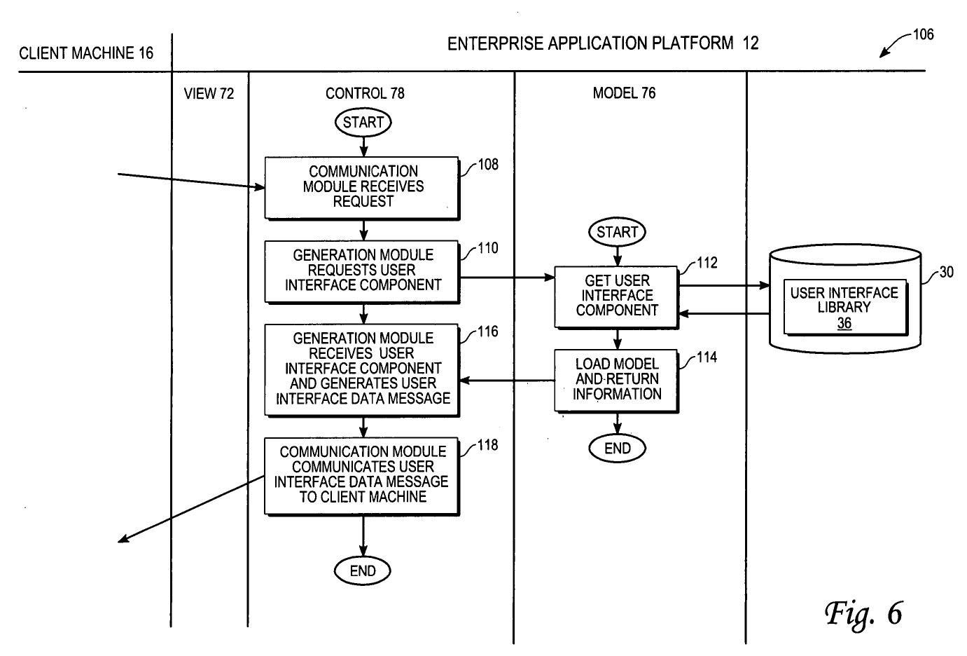

At box 104, the enterprise application platform 12 receives the request for the web page, generates a user interface data message 101 and communicates the user interface data message 101 to the client machine 22 as illustrated in FIG. 6, according to an embodiment.

On FIG. 6, at box 108, the communication module 66, at the enterprise application platform 12, receives the request for the web page and invokes the generation module 64.

At box 110, the generation module 64 instantiates a user interface model 83 at box 112 and utilizes the request to identify the corresponding user interface component(s) 86 in the user interface library 36 in the database 30.

At box 114, the user interface model 83 is populated with data from the user interface library 36 and the user interface component(s) 86 is returned to the generation module 64.

At box 116, the generation module 64 receives the user interface component 86 and generates a user interface data message 101 by including the user interface component in the user interface data message 101.

At box 118, the communication module 66 communicates the user interface data message 101 to the client machine 16 and the processing ends.

Returning to FIG. 5, at box 120, the web client 18, at the client machine 16, reads the user interface data message 101 into memory, displays the Human Resource Information web page and passes control to the user interface controller 87.

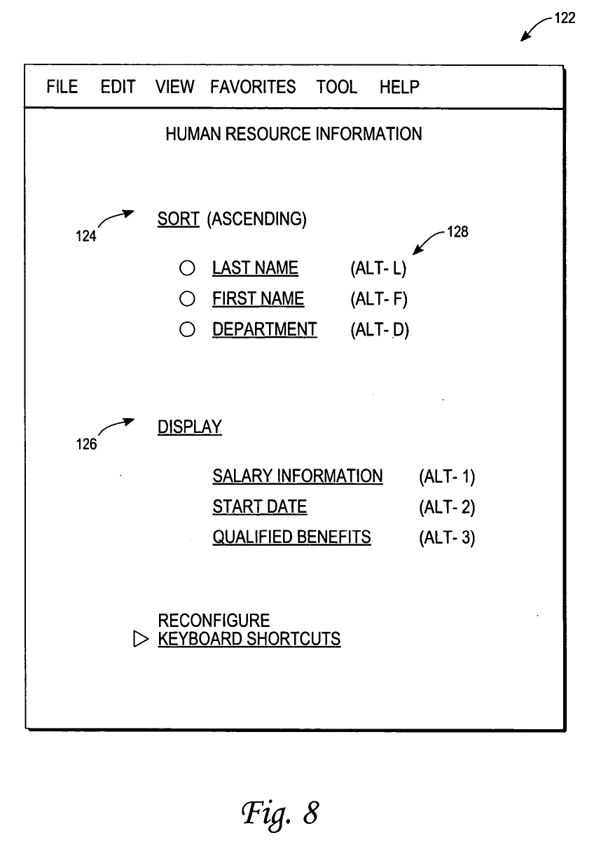

FIG. 8 illustrates a user interface 122, according to an embodiment, in the form of a Human Resource Information web page that includes radio buttons 124 to select the type of sorting of human resource information and links 126 for displaying human resource information. The user interface elements 124 and 126 may be selected from the web page for example by pointing and clicking a mouse or by entering the designated keyboard input. For example, radio button “Last Name” may be selected by entering keyboard input 128 “ALT-L”.

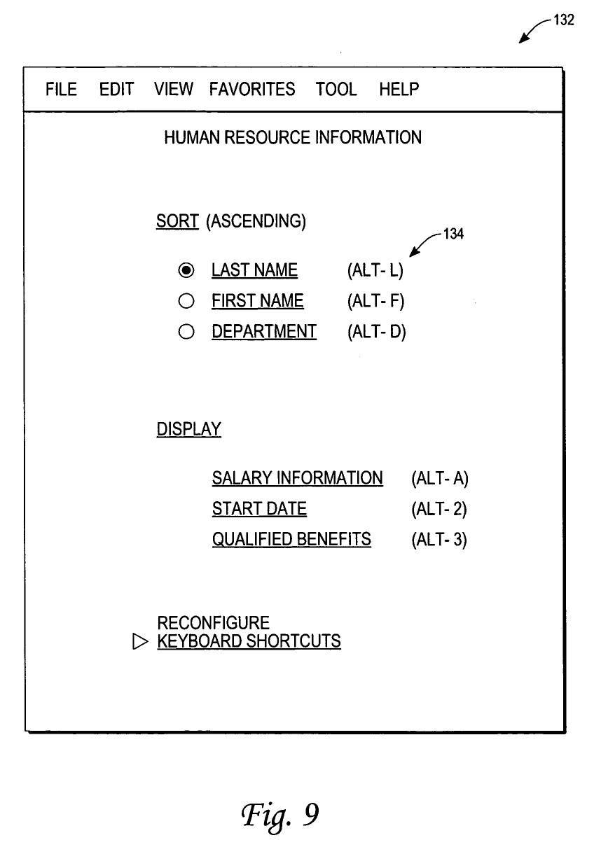

Returning to FIG. 5, at box 130, the user enters “ALT-L” at the keyboard. In response, the dispatch module 78 in the user interface controller 87 receives a keyboard-input event 73 that includes the keyboard input. The dispatch module 78 compares the keyboard input with the modifier 84 field and the key 96 field associated with each entry in the control library 90 to identify a match. If the dispatch module 78 identifies a match then a corresponding activity module 80 is invoked 80. In the present example, the corresponding activity module 80 registers the radio button as selected on the client machine 16 display by invoking the DOM engine 17, as illustrated in FIG. 9.

FIG. 9 illustrates a user interface 132, according to an embodiment, in the form of a Human Resource Information web page that includes a registered radio button 134.

Returning to FIG. 5, at box 136, the user at the client machine 22 selects “Salary Information” by inputting the keystrokes “ALT-A” from the keyboard thereby triggering a keyboard-input event 75 that is communicated to the dispatch module 78. In response, the dispatch module 78 utilizes the keyboard-input event 75 to identify and invoke the appropriate activity module 80 that requests the “Salary Information” web page from the enterprise application platform 12.

At box 104, the enterprise application platform 12 receives the request for the “Salary Information” web page, generates a user interface data message 101 and communicates the user interface data message 101 to the client machine 22 as previously described and illustrated in FIG. 6, according to an embodiment.

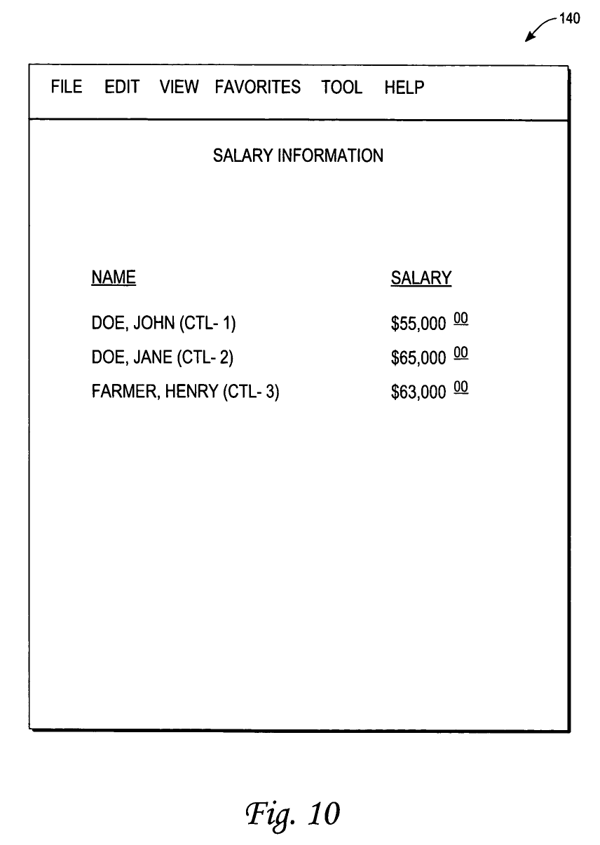

At box 138, the user interface controller 87 displays the “Salary Information” web page and processing ends. FIG. 10, illustrates a user interface 140, according to an embodiment, in the form of a “Salary Information” web page.

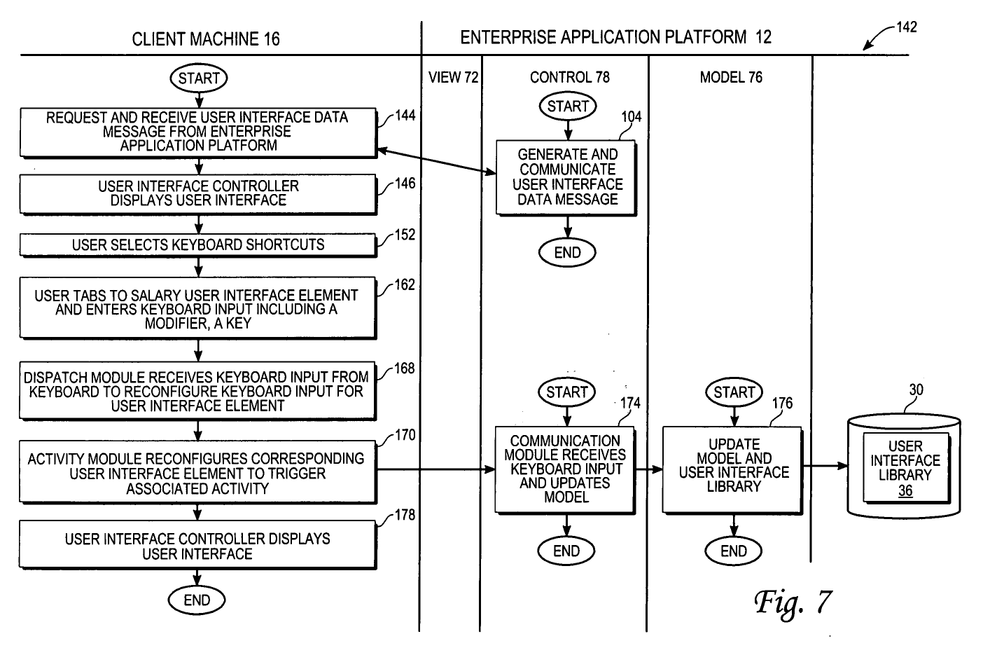

FIG. 7 illustrates a method 142, according to an embodiment, to reconfigure keyboard input that is utilized to trigger an activity associated with a user interface element on a web page. The client machine 16 is illustrated on the left and the enterprise application platform 12 is illustrated on the right.

At box 144, a user at the client machine 22 selects a link for a Human Resource Information web page. In response, the client machine 16 communicates a request for the “Human Resource Information” web page to the enterprise application platform 12.

At box 104, the enterprise application platform 12 receives the request for the “Human Resource Information” web page, generates a user interface data message 101 and communicates the user interface data message 101 to the client machine 16, as previously described and illustrated in FIG. 6, according to an embodiment.

Returning to FIG. 7, at box 146, the web client 18, at the client machine 16, reads the user interface data message 101 into memory, displays the Human Resource Information web page and passes control to the user interface controller 87.

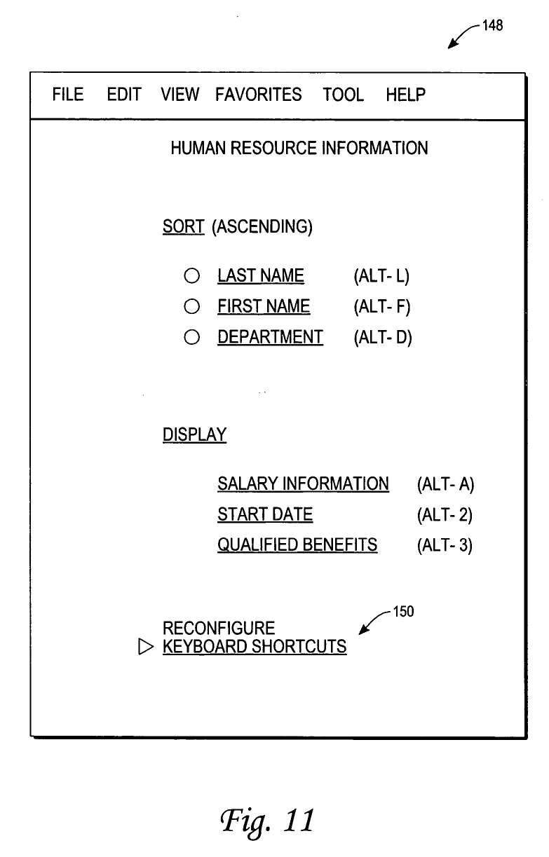

FIG. 11 illustrates a user interface 148, according to an embodiment, in the form of a Human Resource Information web page that includes a “reconfigure keyboard shortcuts” user interface element 150.

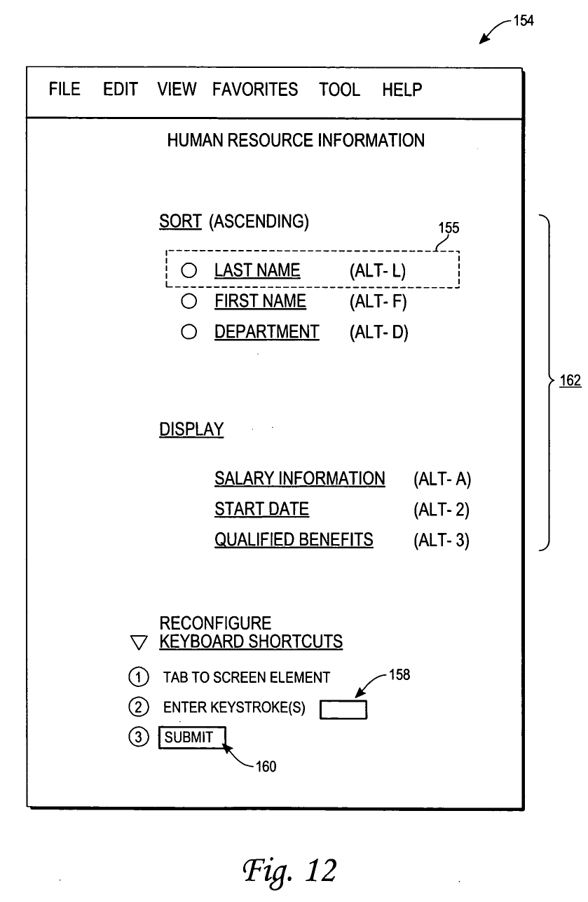

Returning to FIG. 7, at box 152, the user select the “reconfigure keyboard shortcuts” user interface element 150. In response, the dispatch module 78 utilizes the control library 90 to identify and invoke the appropriate activity module 80 which invokes the DOM engine 71 to update the user interface 148 to add user interface elements below the “reconfigure keyboard shortcuts” user interface element 150 as illustrated on FIG. 12.

FIG. 12 illustrates a user interface 154, according to an embodiment, for a “Human Resource Information” web page that includes a user interface element 162 that to reconfigure keyboard shortcuts. The user interface 154 includes user interface elements 162 associated with configurable keyboard shortcuts (e.g., ALT-L, ALT-F, ALT-D, ALT-A, ALT-2, ALT-3) a keystroke box 158, and a submit element 160.

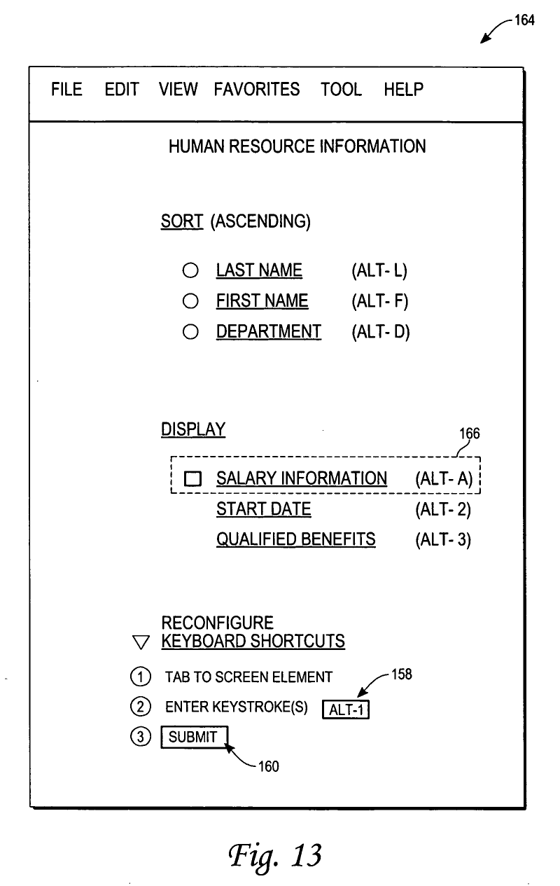

Returning to FIG. 7, at box 162, the user interface controller 87 receives keyboard-input events 73 in response to the user selecting the tab key on the keyboard. The dispatch module 78 receives and processes a keyboard-input event 73 for each selection of the tab key. The dispatch module 78 invokes the corresponding activity module 80 to advance the tab selection 155, round robin, through each of the user interface elements 162. FIG. 13 illustrates a user interface 164, according to an embodiment, that includes a salary information hypertext link 166 that has been selected, a keystroke box 158, and a submit key 160. The salary information hypertext link 166 may be selected by entering the keystrokes “ALT-A” from the keyboard; however, the user desires to change the keystrokes to “ALT-1”. Accordingly, the user enters a modifier keystroke 94 “ALT” and a key keystroke “1” into the keystroke box 158 and selects the submit key 160.

At box 168, the dispatch module 78 receives and processes the keyboard-input event 73 by identifying the corresponding activity module 80.

At box 170, the activity module 80 reconfigures the salary information link 166 by updating the user interface storage 88, updating the user interface library 36 and updating the user interface 164. The activity module 80 updates the user interface storage 88 by storing “ALT” in the modifier 94 field and “1” in the key 96 field in the appropriate entry in the control library 90 in the user interface storage 88. In addition, the activity module 80 communicates the updated keyboard shortcut to the enterprise application platform 12.

At box 174, the communication module 66 receives the keyboard shortcut and communicates the keyboard shortcut to the corresponding user interface model 83.

At box 176, the user interface model 83 stores the keyboard shortcut in local memory and persistently saves the keyboard shortcut in the user interface library 36 in the database 30.

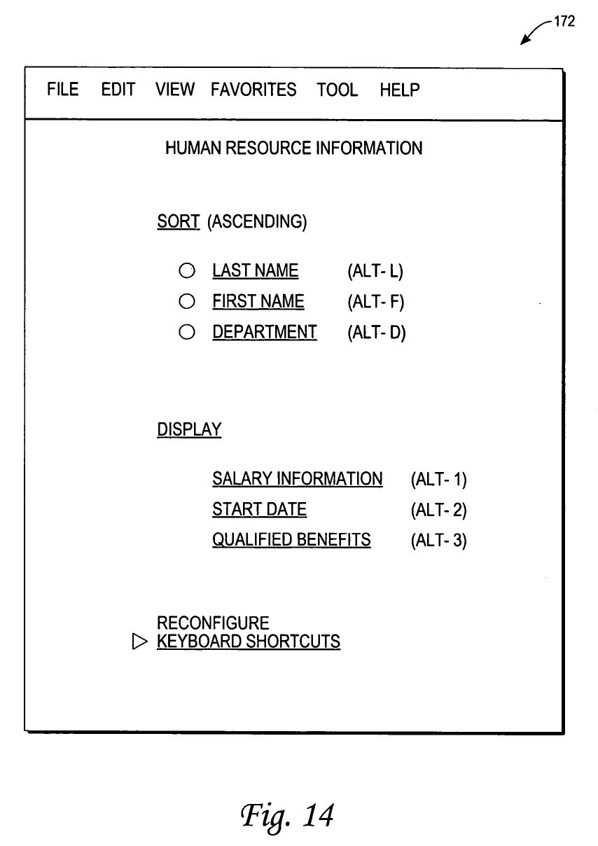

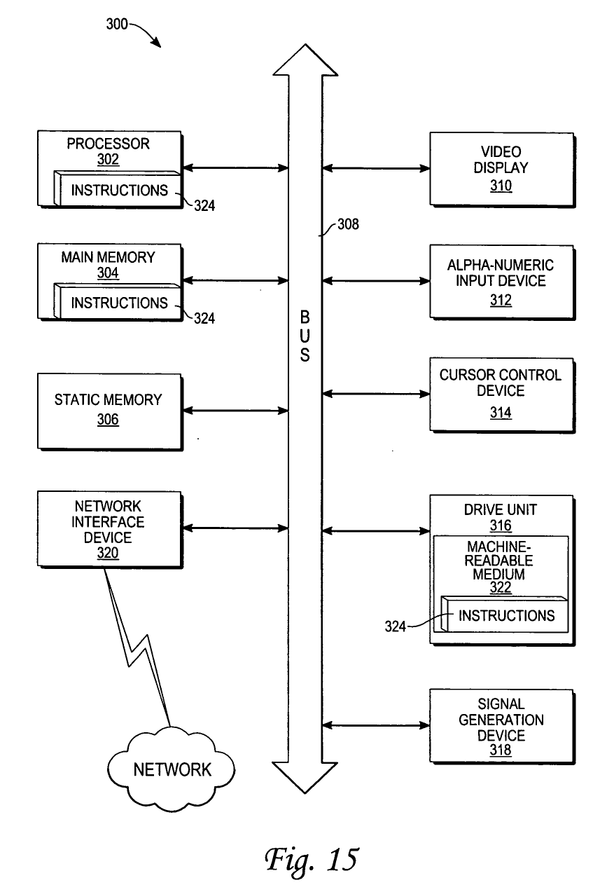

At box 178, the activity module 80 updates the user interface 164 by displaying “ALT-1” as the keyboard shortcut (e.g., keystrokes) that will trigger the activity associated with the salary information link 166. FIG. 14 illustrates a user interface 172, according to an embodiment, that includes the updated keyboard shortcut for the salary information hypertext link 166.

The above-described embodiments illustrated a user operating a client machine 16 that included a web client 18 (e.g., smart browser) with scripting (e.g., JavaScript) enabled. It will be appreciated that processing is quite similar in an embodiment that includes a user operating a small device client machine 22 (e.g., a hand held device, PDA) or client machine 16 with a web client 18 (e.g., smart browser) with scripting (e.g., JavaScript) disabled or a web client 18 that does not support scripting (e.g., dumb browser). In the latter embodiments the user interface controller 87 executes on the enterprise application platform 12 to receive and process input events 77 and to generate or regenerate web pages that are communicated to the client side.

FIG. 10 shows a diagrammatic representation of a machine or platform in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to trigger an activity associated with a user interface element on a web page have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A system to trigger an activity associated with a user interface element on a web page, the system including:
at a first machine, a generation module to generate a user interface data message that includes a user interface controller to receive keyboard input that includes at least one keystroke from a keyboard associated with a second machine, the at least one keystroke to trigger the activity associated with the user interface element on the web page; and
a communication module to communicate the user interface data message from the first machine to the second machine.

2. The system of claim 1, wherein the user interface element includes at least one of a radio button and a hypertext link.

3. The system of claim 1, wherein the activity includes updating the radio button and to link to a web page.

4. The system of claim 1, wherein the keystroke is at least one of a modifier keystroke and a key keystroke.

5. The system of claim 1, wherein the keyboard supports a plurality of keyboard scripts.

6. The system of claim 5, wherein the plurality of keyboard scripts includes a any one of a group of keyboard scripts including an Arabic keyboard script, a Baltic keyboard script, a Central European keyboard script, a Cyrillic keyboard script, a Greek keyboard script, a Hebrew keyboard script, a Turkish keyboard script and a Western keyboard Script.

7. The system of claim 1, wherein the user interface controller is a script.

8. A method to trigger an activity associated with a user interface element on a web page, the method including:
at a first machine, generating a user interface data message that includes a user interface controller to receive keyboard input that includes at least one keystroke from a keyboard associated with a second machine, the at least one keystroke triggering the activity associated with the user interface element on the web page; and
communicating the user interface data message from the first machine to the second machine.

9. The method of claim 8, wherein the user interface element includes at least one of a radio button and a hypertext link.

10. The method of claim 8, wherein the activity includes updating the radio button and linking to a web page.

11. The method of claim 8, wherein the keystroke includes any one of a modifier keystroke and a key keystroke.

12. The method of claim 8, wherein the keyboard supports a plurality of keyboard scripts.

13. The method of claim 8, wherein the plurality of keyboard scripts includes a any one of a group of keyboard scripts including an Arabic keyboard script, a Baltic keyboard script, a Central European keyboard script, a Cyrillic keyboard script, a Greek keyboard script, a Hebrew keyboard script, a Turkish keyboard script and a Western keyboard Script.

14. The method of claim 8, wherein the user interface controller is a script.

15. A system to trigger an activity associated with a user interface element on a web page, the system including:
a dispatch module to receive keyboard input that includes at least one keystroke entered from a keyboard; and
an activity module to trigger the activity associated with the user interface element on the web page based on the at least one keystroke.

16. The system of claim 15, wherein the user interface element includes at least one of a radio button and a hypertext link.

17. The system of claim 15, wherein the user interface controller is a script.

18. A method to trigger an activity associated with a user interface element on a web page, the method including:
receiving keyboard input that includes at least one keystroke entered from a keyboard; and
triggering the activity associated with the user interface element on the web page based on the at least one keystroke.

19. The method of claim 18, wherein the user interface element includes at least one of a radio button and a hypertext link.

20. The method of claim 18, wherein the user interface controller is a script that is embedded in the web page.

21. A system to reconfigure keyboard input that is utilized to trigger an activity associated with a user interface element on a web page, the system including:
at a first machine, a generation module to generate a user interface data message that includes a user interface controller to receive keyboard input that includes the at least one keystroke entered from a keyboard associated with a second machine, the at least one keystroke being a reconfiguration of the keyboard input that is utilized to trigger the activity associated with the user interface element on the web page; and
a communication module to communicate the user interface data message from the first machine to the second machine.

22. The system of claim 21, wherein the user interface data message includes meta-data and page description language for a web page.

23. The system of claim 21, wherein the communication module receives the at least one keystroke.

24. The system of claim 21, wherein the at least one keystroke is displayed in association with the user interface element that is displayed on the web page.

25. A method to reconfigure keyboard input that is utilized to trigger an activity associated with a user interface element on a web page, the method including:
at a first machine, generating a user interface data message that includes a user interface controller to receive keyboard input that includes the at least one keystroke entered from a keyboard associated with a second machine, the at least one keystroke being a reconfiguration of the keyboard input that is utilized to trigger the activity associated with the user interface element on the web page; and
communicating the user interface data message from the first machine to the second machine.

26. The method of claim 25, wherein the user interface data message includes meta-data and page description language for the web page.

27. The method of claim 25, further including receiving the at least one keystroke.

28. The method of claim 25, wherein the at least one keystroke is displayed in association with the user interface element that is displayed on the web page.

29. A system to reconfigure keyboard input that is utilized to trigger an activity associated with a user interface element on a web page, the system including:
a dispatch module to receive keyboard input that includes the at least one keystroke entered from a keyboard; and
an activity module to reconfigure the keyboard input that is utilized to trigger the activity associated with the user interface element on the web page.

30. The system of claim 29, further the activity module to communicate the at least one keystroke to a server.

31. The system of claim 29, wherein the at least one keystroke is displayed in association with the user interface element that is displayed on the web page.

32. A method to reconfigure keyboard input that is utilized to trigger an activity associated with a user interface element on a web page, the method including:
receiving keyboard input that includes the at least one keystroke entered from a keyboard; and
reconfiguring the keyboard input that is utilized to trigger the activity associated with the user interface element on the web page.

33. The method of claim 32, further including communicating the at least one keystroke to a server.

34. The method of claim 32, wherein the at least one keystroke is displayed in association with the user interface element that is displayed on the web page.

35. A machine readable medium storing a set of instructions that, when executed by a machine, cause the machine to:
at a first machine, generate a user interface data message that includes a user interface controller to receive keyboard input that includes at least one keystroke entered from a keyboard associated with a second machine, the at least one keystroke to trigger the activity associated with the user interface element on the web page; and
communicate the user interface data message from the first machine to the second machine.

36. A machine readable medium storing a set of instructions that, when executed by a machine, cause the machine to:
receive keyboard input that includes at least one keystroke entered from a keyboard; and
trigger the activity associated with the user interface element on the web page based on the at least one keystroke.

37. A machine readable medium storing a set of instructions that, when executed by a machine, cause the machine to:
at a first machine, generate a user interface data message that includes a user interface controller to receive keyboard input that includes the at least one keystroke entered from a keyboard associated with a second machine, the at least one keystroke being a reconfiguration of the keyboard input that is utilized to trigger the activity associated with the user interface element on the web page; and
communicate the user interface data message from the first machine to the second machine.

38. A machine readable medium storing a set of instructions that, when executed by a machine, cause the machine to:
receive keyboard input that includes the at least one keystroke entered from a keyboard; and
reconfigure the keyboard input that is utilized to trigger the activity associated with the user interface element on the web page.

39. A system to reconfigure keyboard input that is utilized to trigger an activity associated with a user interface element on a web page, the system including:
a first means to receive keyboard input that includes the at least one keystroke entered from a keyboard; and
a second means to reconfigure the keyboard input that is utilized to trigger the activity associated with the user interface element on the web page.
